(19) United States
(12) Patent Application Publication
(10) Pub. No.: US 2011/0276889 A1
(43) Pub. Date: Nov. 10, 2011

(54) ONLINE BOOKMARKING SYSTEM

(76) Inventor: YANIV BOSHERNITZAN, Houston, TX (US)

(21) Appl. No.: 12/776,280

(22) Filed: May 7, 2010

(51) Int. Cl. G06F 3/048

(52) U.S. Cl. 715/738

(57) ABSTRACT

An online bookmarking system enabling a logged-in user to assemble, organize and access personal web links from any online location through a user-specific uniform resource locator is disclosed. The system comprises a bookmark adding button enabling the Internet user to add a currently visited webpage to a user-specific database of server-stored bookmarks, a floating module displayed on the logged-in specific database for synchronizing with the bookmark adding button for adding bookmarks, a plurality of web link modules categorized by the user, and a private module for maintaining at least one confidential link of the user with a security identification means. Each of the web link modules can be titled relevant to a category and the web links may be repositioned within and between the web link modules using a drag-and-drop interface. The web link modules may also be dragged and dropped above or below other web link modules.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to bookmarking systems, and more particularly to an online bookmarking system enabling an Internet user to assemble, organize and access personal web bookmarks from any online location through a user-specific uniform resource locator.

### DISCUSSION OF RELATED ART

The development of computerized distributed information resources, such as the “Internet,” allows users to link to a computer network and retrieve vast amounts of information previously unavailable in an electronic medium. Such electronic information displaces more conventional means of information transmission, such as newspapers, magazines, and even television. As the Internet becomes a more integral part of our lives and the number of websites that we need to access expands, the ability to quickly save and access a growing list of web bookmarks becomes more important.

Various new bookmarking offerings have emerged to address expanding needs and to improve upon older methods of bookmarking Although bookmarking originated as a browser-based tool which was difficult to migrate or access from multiple computers, new web-based bookmarking services such as Delicious.com offer internet users access to their bookmarks from any online access point via a personal URL. They also make it easy to share links and pool web-resources with other people through the internet.

While these services solve the issue of portability, they fail to remedy a number of other problems inherent to browser-bookmarks. Web-based bookmarking services store is bookmarks on multiple pages or in hierarchal directories similar to the menu-interface of browser bookmarks. Both of these interfaces prevent quick access to bookmarks and cause bookmarks to become lost or stale bookmarks due to lack of visibility of all bookmarks on a single page or menu list. Although these web services are sometimes supplemented by a search feature, finding a bookmark inevitably necessitates multiple keyboard entries or mouse-clicks to navigate to a specific bookmark if it is not displayed on the current page-view. Furthermore, modifying the categorization of existing bookmarks is a two-step process requiring the selection of an editing interface specific to each individual bookmark, followed by entry of the bookmark's new category via typed-input or menu selection.

Web-based bookmarking services also disrupt the smooth flow of web-surfing. Unlike browser bookmarks which seamlessly support the ability to bookmark a page without leaving it, web-based services generally require navigation away from the page a user seeks to bookmark to a dedicated bookmarking page, after which the user is then returned to the original bookmarked page. This navigation procedure is particularly problematic if the original page has dynamic content or has user-inputted text, as these dynamic contents or textual inputs will be lost upon returning to the original page.

Another limitation of web-based bookmarking services relates to privacy. Although most of these services allow a user's bookmarks to be set to a private status to avoid being viewed by strangers who remotely access a user's public bookmark URL, online bookmarking services fail to address the privacy concerns of the user who shares a specific computer that has a saved log-in session to the user's web-based bookmarking account. In essence, logging in is the only layer of security for online bookmarking tools, even though such tools typically default to keep users continuously logged-in, thereby making bookmarks marked private vulnerable to prying eyes. Furthermore, the ability to set a bookmark to a private status is often an inconspicuous feature, lacking prominent integration.

Because of this lack of robust privacy, online bookmarking solutions have tended to gravitate toward social usage rather than personal usage. While social features of bookmarking have merit as a means to share and discover useful online content as a supplement to a user's primary bookmarks, it is incongruous with the personal nature of primary bookmarks. Most internet users frequently access websites of a personal nature such as online banking sites, medical sites, email services, adult sites, etc and have therefore preferred to store their bookmarks locally rather than online.

Recognizing the aversion of many internet users to web-based bookmarks, some services have combined the privacy benefits of browser bookmarks with the portability benefits of web-based bookmarks. One such service Xmarks.com, offers synchronization between bookmarks stored in browsers and an online server. This enables users to access bookmarks within a browser menu's interface from multiple online locations, and to easily migrate bookmarks from one computer to another. However, the service still has is the same navigational shortcomings as browser-based and web-based bookmarking methods in terms of requiring multiple steps to access or organize bookmarks. Xmarks.com also requires installation of software to integrate with browsers. The compatibility of this software is limited to discrete operating systems and browsers for which compatible software must be specifically written. Furthermore, such bookmarks can only be accessed or shared by users who are signed-in. This makes it difficult to quickly retrieve bookmarks from a computer that does not have the synchronization software already installed, or which is not currently signed in to the user's account.

Therefore, there is a need for a bookmarking system that combines privacy and portability, while also offering efficiency and ease of use. Such a system would make saving, accessing, and sharing links easy while still providing prominent privacy options for private links. The system would also serve as a portal or start page for users, offering one-click access and organization of favorite links from a single online page. The present invention accomplishes these objectives.

### SUMMARY OF THE INVENTION

The present invention is an online bookmarking system that enables a logged-in user to assemble, organize and access personal web links from any online location through a user-specific uniform resource locator (URL). The online bookmarking system comprises a bookmark adding button for enabling the logged-in user to add a currently visited webpage to the logged-in user-specific database of server-stored bookmarks, a floating module which is displayed on the logged-in specific database for synchronizing with the bookmark adding button for adding bookmarks, a plurality of web link modules categorized by the logged-in user, and a private module for maintaining at least one confidential link of the logged-in user with a security identification means. Each of the web link modules can be titled by the logged-in user relevant to at least one category. The logged-in user may also be able to drag-and-drop the web link modules to any position above or below the other web link module on the personalized page.

As the logged in user's web link modules are arranged on a single page, every web link can be organized, and accessed with a single click. If the volume of saved web link modules exceeds the space available on one page, one-click access is possible by using the mouse's scroll apparatus or another scrolling interface to move up or down the vertical area of the page. The floating module may be updated with bookmarked links in real-time as the logged-in user adds web links to his or her personalized webpage through the button activated interface. The online bookmarking system enables the logged-in user drag web links directly from the floating module to the destination web link module. The online bookmarking system may also provides a private module whereby the logged-in user can easily hide confidential web links so that the web links are not accessible to anyone else who may visit the user's URL or access the user's computer. Although anyone can view the Internet user's non-private links through their personal URL, the logged on (not shown) must both login and enter a correct privacy pin to access links hidden in the privacy tab.

The bookmark adding button may allow the logged-in user to enter details of a bookmark without leaving the currently visited webpage and/or losing any selections and/or text the logged on user has typed into text-fields on the currently visited webpage. The logged-in user accessing the online bookmarking system can share his or her personalized page except private links through their publicly accessible personal URL and can also share categories of web links using a web link to a single web link module or by embedding the web link modules into html supporting interface such as a blog, message board, or website.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a window or webpage of the present invention in the logged-out state, illustrating a plurality of web bookmarks and a log-in button for an Internet user;

FIG. 2 is a logged-in state personalized webpage that illustrates a clutterbar, a plurality of clusters and a private module of the present invention;

FIG. 3 is a user-visited webpage to be bookmarked that illustrates a bookmark adding button associated to the online bookmarking system for generating an in-page bookmark adding interface of the present invention; and

FIG. 4 is an operational flow chart of the preferred embodiment in accordance with the present invention, illustrating a method of an online bookmarking system to assemble, organize and access personal web bookmarks from any online location through a user-specific uniform resource locator.

### DETAILED DESCRIPTION OF THE PREFERRED EMBODIMENT

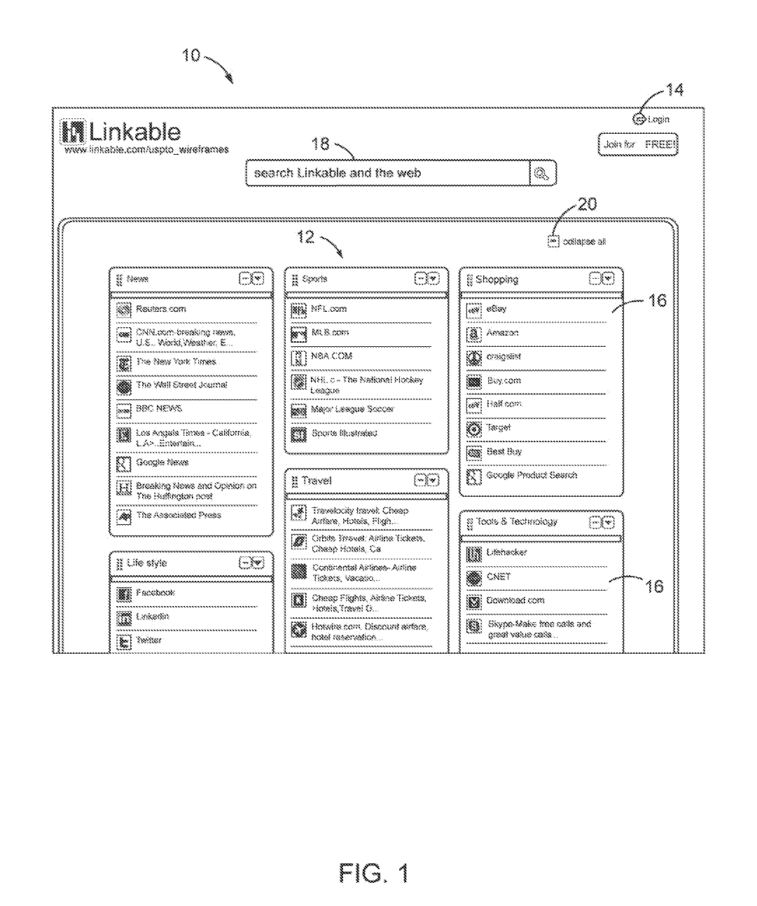

FIG. 1 is a window or webpage 10 of the present invention, illustrating a plurality of web link modules 12 and a log-in button 14 for an Internet user (not shown) to access his or her personalized web page (not shown) through a user-specific uniform resource locator (URL). A search button 18 on the webpage 10 facilitates searching of the plurality of web bookmarks 16 in the plurality of web link modules 12 and Internet. The web link modules 12 may be collapsed or expanded as needed using a collapse actuating button 20. When the Internet user (not shown) accesses the plurality of web bookmarks 16 through his or her personal URL from a remote location without logging into his or her accounts, logged-out view of the personalized web page 10 entirely hides any private module that may exist (not shown). Although anyone can view the Internet user's non-private links through user's personal URL, the Internet user (not shown) must both login and enter a correct privacy pin to access links hidden in the private module (not shown).

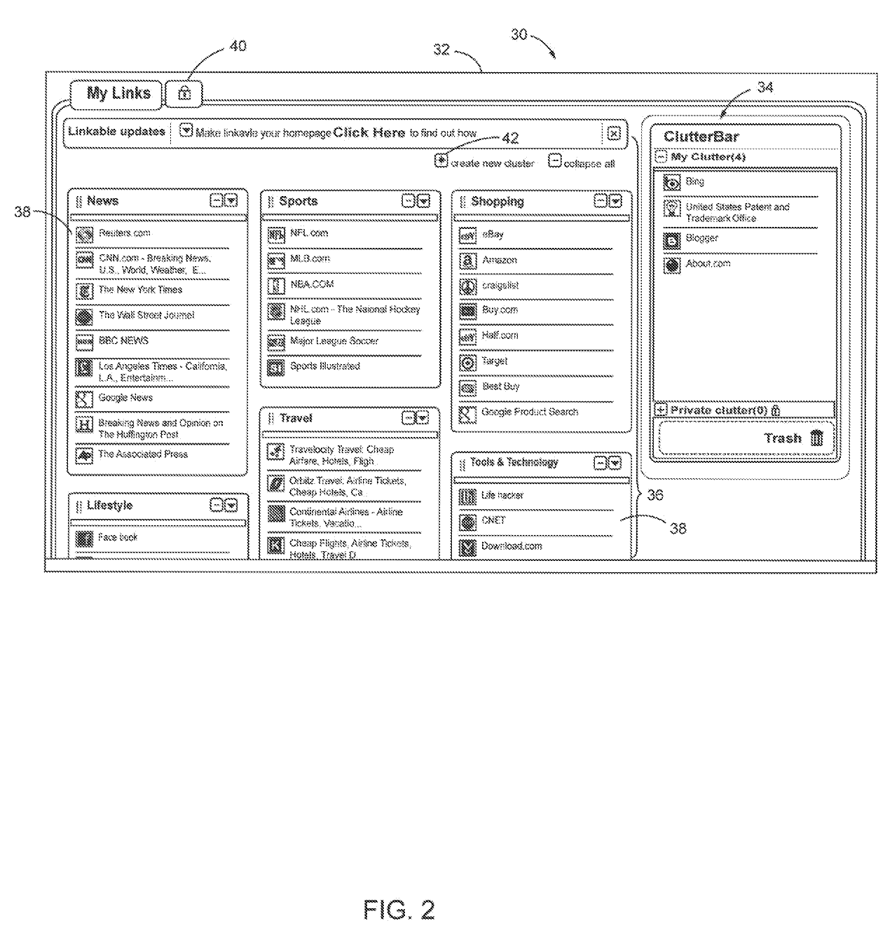

Referring to FIG. 2, the major components of the online bookmarking system 30 are illustrated. The online bookmarking system 30 enables a logged-in user (not shown) to assemble, organize and access a plurality of personal web links 38 from any online location through a user-specific uniform resource locator. The online bookmarking system 30 comprises a floating module 34 (the floating module referred to as a “clutterbar” hereinafter) displayed on a user specific web page or interface for synchronizing with the bookmark adding button for adding bookmarks, a plurality of web link modules 36 (the web link modules referred to as a “cluster” hereinafter) categorized by the logged-in user (not shown), and a private module 40 for maintaining at least one confidential link (not shown) of the logged-in user (not shown) with a security identification means. The logged in user (not shown) can create clusters 36 by clicking on a button for creating a new cluster 42 on a logged on user's menu area. Each of the clusters 36 can be titled by the logged-in user (not shown) relevant to at least one category. The logged-in user (not shown) may also drag-and-drop the clusters 36 to any position within and between the other clusters 36 on the personalized web page 32. In addition to dynamic rearrangement of the clusters 36 through a draggable interface, individual web links 38 may also be dragged up or down within the clusters 36 or between the clusters 36. The clusters 36 may also be collapsed or expanded as needed. This dynamic interface provides for instant organization of bookmark categories, and instant arrangement of web links 38 within those categories. As the logged-in user's clusters 36 are arranged on a single page, every web link 38 can be organized, and accessed with a single click. If the volume of saved clusters 36 exceeds the space available on one page, one-click access is possible by using the mouse's scroll apparatus to move up or down the vertical area of the personalized web page 32. The clusters 36 may also be monetized using contextual advertising relating to the web links 38 contained therein.

The clutterbar 34 may serve as a temporary holding area for bookmarks that the logged-in user (not shown) has saved but not yet categorized. The clutterbar 34 may be updated with bookmarked links in real time as the logged-in user (not shown) adds web links 38 to his or her personalized webpage 32 through the bookmark adding button (not shown). The online bookmarking system 30 enables the logged-in user (not shown) to drag web links 38 directly from the clutterbar 34 to the destination cluster 36. The clutterbar 34 may also provide utility in allowing the logged-in user (not shown) to focus singularly on his or her browsing experience without the distraction of categorizing a bookmark at the time a bookmark is saved and facilitating easy retrieval and categorization at a later point. The clutterbar 34 floats adjacent to the clusters 36 as the logged-in user (not shown) scrolls vertically up or down the personalized web page 32. This floating interface may be achieved by use of tables, frames, or other means. As the clutterbar 34 is always present on the personalized web page 32 regardless of how far down the logged-in user (not shown) has scrolled on the personalized web page 32, the floating interface of the clutterbar 34 preserves the one-click experience of interaction. The clutterbar 34 may contain a delete or archive feature through a drag-and-drop interface, facilitating a delete feature to always be accessible on the personalized web page 32.

The private module 40 provided on online bookmarking system 30 may enable the logged-in user (not shown) to easily hide confidential web links so that the web links 38 are not accessible to anyone who may visit the user's publicly accessible personal URL or access the user's computer. Thus the private module 40 may also provide a second layer of security, for preventing access to the web links 38 contained within the private module 40. The private module 40 may also allow the web links 38 or the clusters 36 to be dragged to and from the private module 40 to toggle the status of web links 38 or the clusters 36 between public and private. By means of the private module 40 the logged-in user (not shown) may be able to safely keep his or her account in a logged in state.

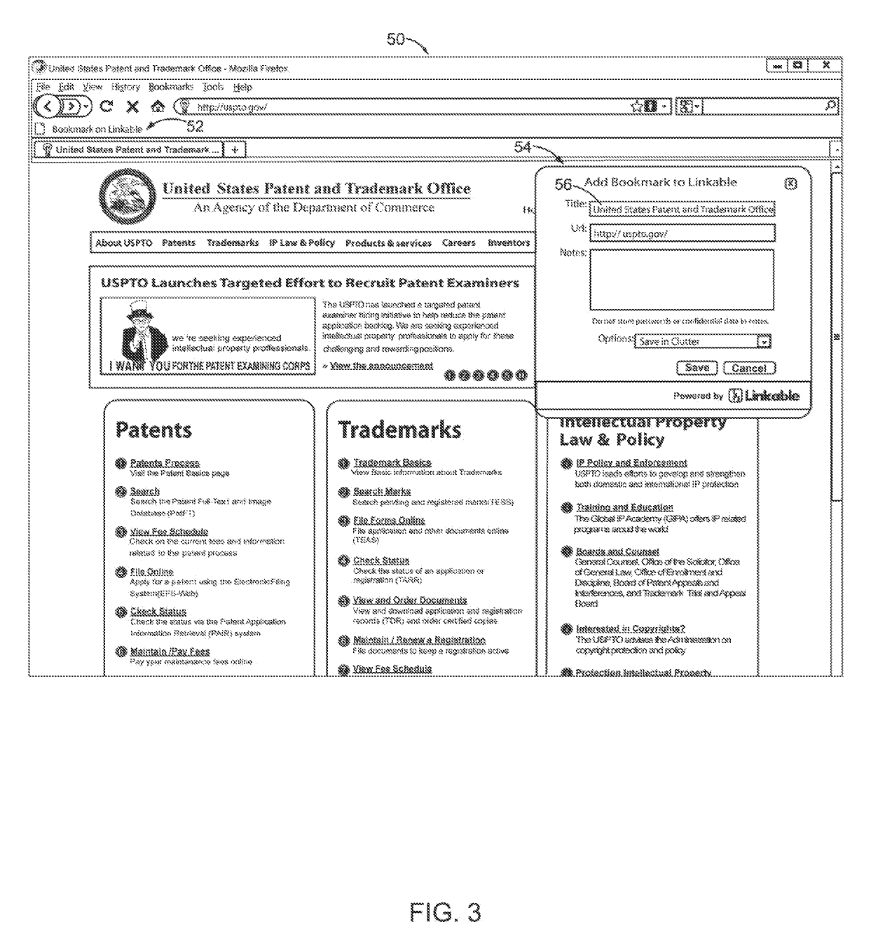

FIG. 3 is a user visited web page 50 showing a bookmark adding button 52 associated to the online bookmarking system 30 to generate an in-page bookmark adding interface 54 for a logged-in user (not shown) to enter details of at least one web bookmark 56. The bookmark adding interface 54 may allow the logged-in user (not shown) to enter details of the at least one web bookmark 56 without leaving the currently visited webpage and/or losing any selections and/or text the logged in user (not shown) has typed into text-fields on the currently visited webpage. The logged-in user (not shown) can save the web links 38 by clicking a bookmark adding button 52 located in the menu area of the logged on user's web browser, without navigating away from the webpage to be bookmarked. Also, the bookmark adding button 52 may not require installation of an application designed specifically for a web browser or operating system.

The logged-in user (not shown) accessing the online bookmarking system 30 can share his or her web page 10 except private links (not shown) through his or her publicly accessible personal URL. The clusters 36 can also be shared through a direct link to a dedicated URL for that the clusters 36, or by embedding the clusters 36 in an html-supporting interface such as blog, message board, or website.

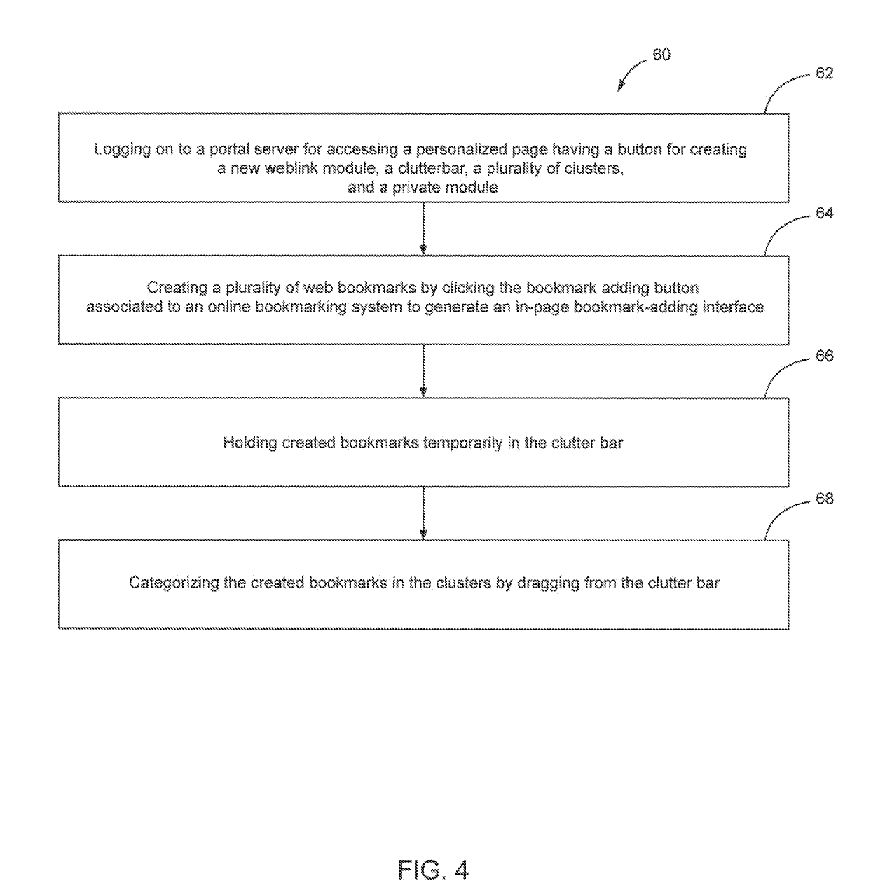

FIG. 4 shows an operational flow chart, illustrating a method of an online bookmarking system 60 to assemble, organize and access personal web bookmarks from any online location through a user-specific uniform resource locator. As indicated at block 62, the logged-in user (not shown) can access a portal server using an Internet compatible device which returns a personalized web page for the logged-in user (not shown), the personalized web page having a button for creating a new cluster, a clutterbar, a plurality of clusters, and a private module. After gaining access to the online bookmarking system, the logged on user can be able to create the plurality of web bookmarks by clicking the bookmark adding button associated to the online bookmarking system to generate an in-page bookmark adding interface as indicated at block 64. After generating an in-page bookmark adding interface, the logged-in user (not shown) can hold created bookmarks temporarily in the clutterbar as indicated at block 66 and then categorize the created bookmarks in the clusters by dragging from the clutterbar as indicated at block 68. The web links may be repositioned within the clusters and between the clusters using a drag-and-drop interface.

While a particular form of the invention has been illustrated and described, it will be apparent that various modifications can be made without departing from the spirit and scope of the invention. Accordingly, it is not intended that the invention be limited, except as by the appended claims.

What is claimed is:

1. An online bookmarking system enabling an Internet user to assemble, organize and access a plurality of personal web bookmarks from any online location through at least one user specific uniform resource locator (URL) comprising:
a bookmark adding button enabling the Internet user to add a currently visited webpage to a user-specific database of server-stored bookmarks;
a floating module displayed on a user specific web page or interface for synchronizing with the bookmark adding button for adding bookmarks;
a plurality of web link modules categorized by the Internet user, each of the web link module being titled by the user relevant to at least one category; and

2. The online bookmarking system of claim 1 wherein the bookmark adding button generates an in-page overlayed interface, thereby allowing the user to save at least one web bookmark without leaving the currently visited webpage and/or losing any selections and/or text the user has typed into text-fields on the page.

3. The online bookmarking system of claim 1 further comprising a private module for maintaining at least one confidential link of the Internet user with a security identification means.

4. The online bookmarking system of claim 1 wherein the bookmark adding button may not require installation of an application designed specifically for a web browser or operating system.

5. The online bookmarking system of claim 1 wherein the floating module may have an ability to retain a fixed position relative to at least one browser window.

6. The online bookmarking system of claim 1 wherein the floating module may contain a delete or archive feature through a drag-and-drop interface, facilitating a ‘delete’ feature to always be accessible on the user's page.

7. The online bookmarking system of claim 1 wherein the web link modules may be embedded to an html-supporting platform to share categories of web links.

8. The online bookmarking system of claim 1 wherein the web link modules may be monetized using contextual advertising relating to the web links contained therein.

9. The online bookmarking system of claim 1 wherein the user can drag web links directly from the floating module to a destination web link modules.

10. The online bookmarking system of claim 1 wherein the private modules may also be accessed through a collapsible section of a web page, a separate page accessed through a link, and/or a variety of other interfaces.

11. The online bookmarking system of claim 1 wherein the web link modules may be dragged and dropped to any position within and between the web link modules.

12. The online bookmarking system of claim 1 wherein the private module ensures protection of private links while accessing bookmarks through the user's personal URL remotely.

13. A method of an online bookmarking system enabling an Internet user to assemble, organize and access a plurality of personal web bookmarks from any online location through a user-specific uniform resource locator (URL), the method comprising:
(a) logging in to a portal server using an Internet compatible device which returns a personalized page for the user logging in, the personalized page includes a button for creating a new web link module, a floating module, a plurality of web link modules, and a privacy module;
(b) creating the plurality of web bookmarks by clicking a bookmark adding button associated to the online bookmarking system to generate an in-page bookmark-adding interface;
(c) holding created bookmarks temporarily in the floating module; and
(d) categorizing the created bookmarks in the web link modules by dragging from the floating module.

14. The method of claim 12 wherein the links may be repositioned within the web link modules and between the web link modules using a drag-and-drop interface.

15. The method of claim 12 wherein the web link modules may also be dragged and dropped at any position above or below other web link modules.

16. The method of claim 12 wherein the web link modules may be shared through a direct link to a dedicated URL for that web link modules, or by embedding the web link modules in an html-capable blog, message board, and/or website.

17. The method of claim 12 wherein the private module may allow the web links or web link modules to be dragged to and from the private module to toggle the status of web links or web link modules between public and private.
